(19) United States
(12) Patent Application Publication
(10) Pub. No.: US 2014/0236337 A1
(43) Pub. Date: Aug. 21, 2014

(54) PATTERN INSPECTION METHOD AND MANUFACTURING CONTROL SYSTEM

(71) Applicant: KABUSHIKI KAISHA TOSHIBA, Minato-ku (JP)

(72) Inventors: Kenji Kawabata, Yokkaichi-Shi (JP); Toru Koike, Yokkaichi-Shi (JP); Kenichi Kadota, Yokkaichi-Shi (JP)

(73) Assignee: KABUSHIKI KAISHA TOSHIBA, Minato-ku (JP)

(21) Appl. No.: 14/014,715

(22) Filed: Aug. 30, 2013

Related U.S. Application Data
(60) Provisional application No. 61/765,338, filed on Feb. 15, 2013.

(51) Int. Cl. G05B 15/02

(52) U.S. Cl. CPC G05B 15/02
USPC 700/110

(57) ABSTRACT

In accordance with an embodiment, a pattern inspection method includes modeling a shape simulation of a pattern, performing in-line measurement with respect to control parameters which are to be controlled in a manufacturing process of the pattern, executing the shape simulation by using a result of the in-line measurement, and judging acceptance of a pattern shape based on a result of the shape simulation.

### CROSS REFERENCE TO RELATED APPLICATIONS

This application is based upon and claims the benefit of U.S. provisional Application No. 61/765,338, filed on Feb. 15, 2013, the entire contents of which are incorporated herein by reference.

### FIELD

Embodiments relate to a pattern inspection method and a manufacturing control system.

### BACKGROUND

In recent years, with advancement of miniaturization and high integration, a pattern of an intricate three-dimensional configuration including a high-aspect trench bottom or hole bottom is formed on a wafer. For such a pattern, it is difficult to conduct an in-line inspection using conventional optical inspection technology, i.e., a nondestructive inspection in a state that a product can be supplied to the subsequent process during a manufacturing process. Thus, there has been adopted an inspection method in which a given wafer is subjected to a preceding processing and destroyed, and its cross-sectional shape is then observed using a scanning electron microscope or the like.

However, such a destructive inspection has a problem that costs for a wafer subjected to the preceding processing are wasted, and a time required for the inspection is long.

### BRIEF DESCRIPTION OF THE DRAWINGS

In the accompanying drawing,

FIG. 1 is a flowchart showing an outline procedure of a pattern inspection method according to an embodiment;

FIG. 2 is a flowchart showing a more specific procedure of a semiconductor process simulation preparatory procedure in the outline procedure depicted in FIG. 1;

FIG. 3 is a flowchart showing a more specific procedure of an inspection implementation procedure in the outline procedure depicted in FIG. 1;

FIGS. 4A and 4B are views showing a cross-sectional structure and an upper surface structure of an example of a pattern before an etching treatment as an inspection target;

FIG. 5 is a view showing an example of a cross-sectional structure after the etching treatment for the pattern shown in FIGS. 4A and 4B;

FIG. 6 is a view showing an example of an etching model for the pattern shown in FIGS. 4A and 4B; and

FIG. 7 is a block diagram showing an outline configuration of a manufacturing control system according to the embodiment.

### DETAILED DESCRIPTION

In accordance with an embodiment, a pattern inspection method includes modeling a shape simulation of a pattern, performing in-line measurement with respect to control parameters which are to be controlled in a manufacturing process of the pattern, executing the shape simulation by using a result of the in-line measurement, and judging acceptance of a pattern shape based on a result of the shape simulation.

Embodiments will now be explained with reference to the accompanying drawings. Like components are provided with like reference signs throughout the drawings and repeated descriptions thereof are appropriately omitted. Furthermore, in the following description, a virtual inspection of a pattern in which data obtained by in-line measurement and a shape simulation are used will be referred to as a virtual inspection.

(A) Pattern Inspection Method

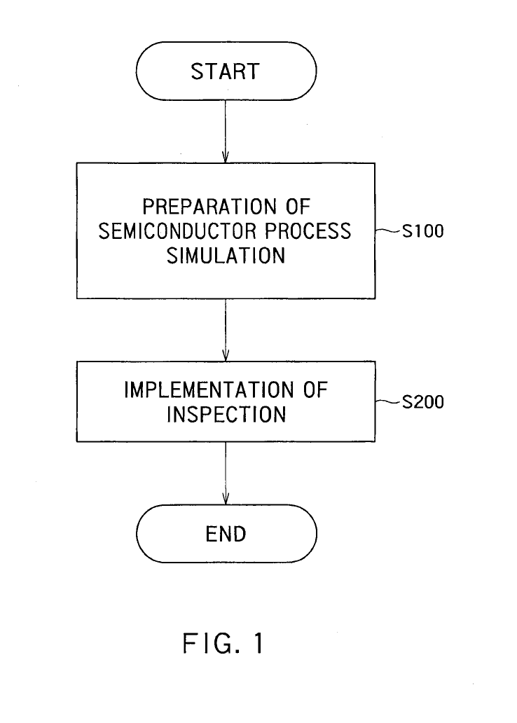

FIG. 1 is a flowchart showing an outline procedure of a pattern inspection method according to an embodiment. The pattern inspection method according to this embodiment uses a virtual inspection, and it is constituted of a shape simulation preparatory procedure (a step S100) and an inspection implementation procedure (a step S200). Each procedure will now be more specifically explained hereinafter.

(1) Preparation of Semiconductor Process Simulation (Step S100)

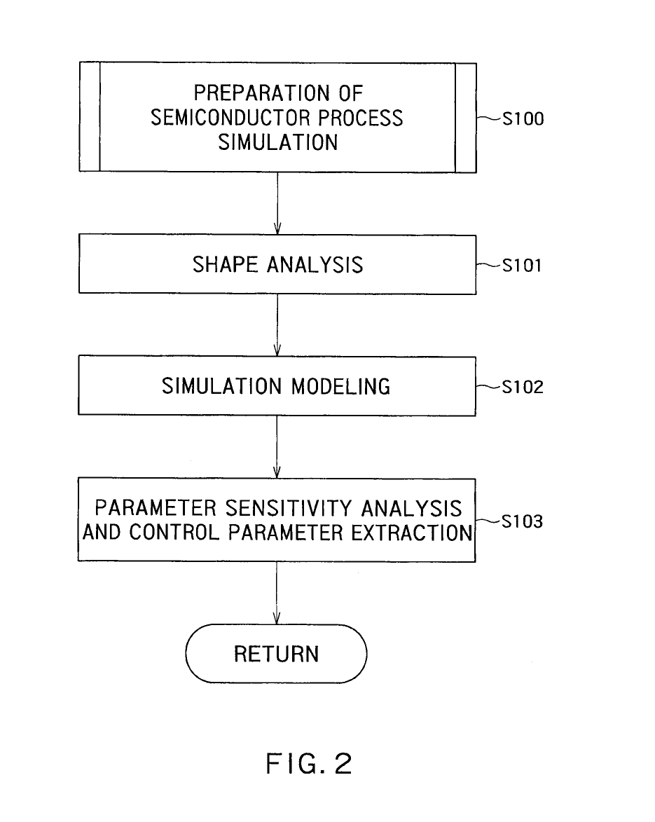

The shape simulation preparatory procedure will now be described with reference to a flowchart of FIG. 2. In this application “shape simulation” means a shape prediction by integrated semiconductor process simulations.

First, in regard to a manufacturing process which is a target of the virtual inspection, a shape of an inspection target pattern is analyzed by an analysis method including a destructive technique (a step S101).

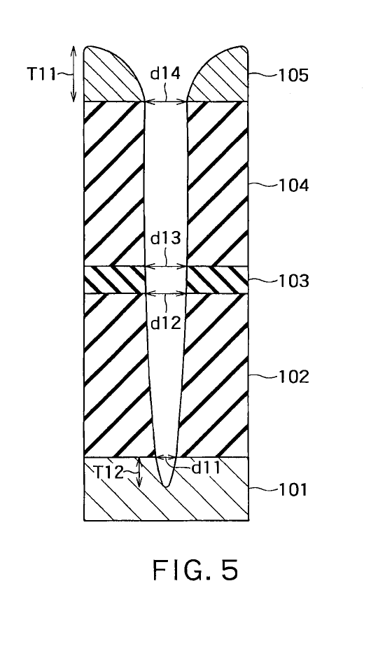

As an example of a target process of the virtual inspection, an etching process of a contact hole having such a cross-sectional shape as shown in FIG. 5 will be explained.

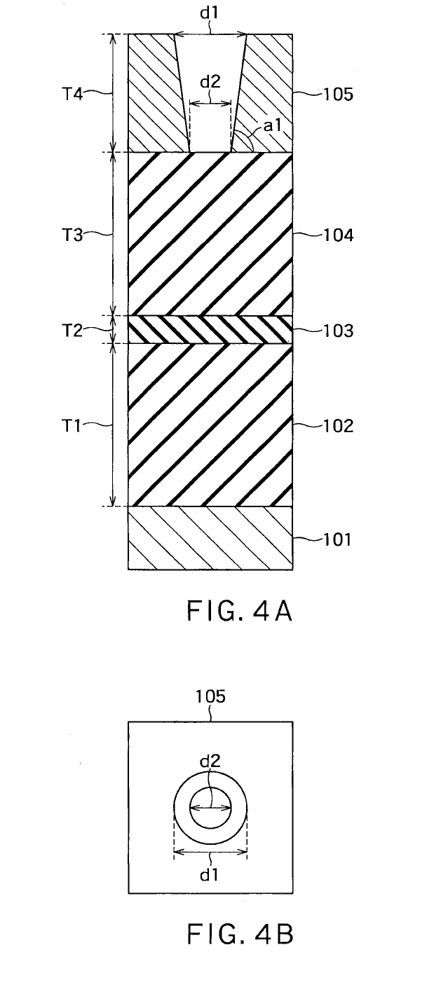

An initial structure of the contact hole shown in FIG. 5 before etching corresponds to a such a cross-sectional shape as shown in FIG. 4A and such an upper surface structure as shown in FIG. 4B. As shown in FIG. 4A, an initial structure of the inspection target pattern is provided by sequentially laminating a silicon oxide film 102, a silicon nitride film 103, and a silicon oxide film 104 on a silicon substrate 101 and forming an organic film hard mask 105 on the silicon oxide film 104 by photolithography. FIG. 4B is a top view of the initial structure of the inspection target pattern and shows that a hole is opened in the organic hard mask 105. The silicon substrate 101 corresponds to, e.g., a wafer in this embodiment. The wafer is not restricted to a semiconductor substrate, and it also includes, e.g., an insulator substrate such as a glass substrate or a ceramic substrate.

FIG. 5 shows a state that a contact hole is formed to reach the inside of the silicon substrate 101 by an etching process using the hard mask 105 as a mask material.

To model the shape simulation, a shape before effecting an etching treatment is identified. Specifically, an actual pattern corresponding to FIG. 4A is formed on the wafer. Then respective film thicknesses T1, T2, T3, and T4 of the silicon oxide film 102, the silicon nitride film 103, and the silicon oxide film 104, a taper angle a1 of the hard mask 105, and a value of a hole top diameter d1 of the hard mask 105 in FIG. 4A are acquired through measurement using a scanning electron microscope (not shown) or a transmission electron microscope (not shown). Likewise, a shape after the etching treatment is measured by using the scanning electron microscope (not shown) or the transmission electron microscope (not shown), values of a film thickness T11 of a mask remaining film, a silicon substrate reduced amount T12, and contact hole diameters d11, d12, d13, and d14 on respective top surfaces of the silicon substrate 101, the silicon oxide film 102, the silicon nitride film 103, and the silicon oxide film 104 shown in FIG. 5 are acquired.

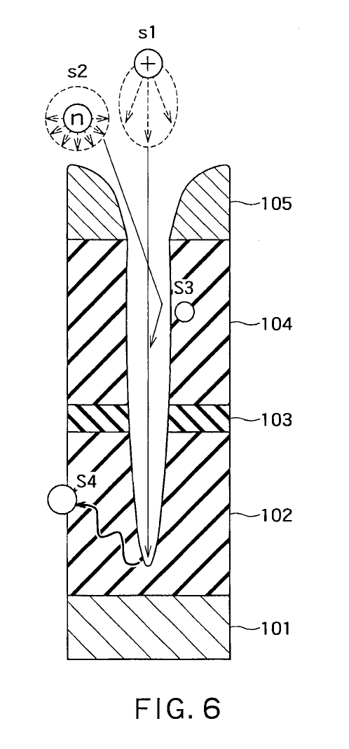

Subsequently, the processing advances to a procedure for modeling the simulation (a step S102 in FIG. 2). As a dimension or a model of the simulation, one that is necessary and sufficient for reproducing a shape of the inspection target pattern is selected. In this embodiment, a three-dimensional etching model with surface reaction model is selected. FIG. 6 shows an outline view of this etching model. Simulation parameters in this simulation model are flux density of an ion type S1 and a neutral type S2, an ion flux spread parameter, and a coefficient of a surface reaction of the ion type and the neutral type on a structure surface. On the surface of the pattern structure, a generating reaction of a surface protective film S3 or an etching reaction S4 occurs, such a reaction is taken in, and the etching process of the contact hole is simulated. FIG. 6 shows a state in the middle of contact hole etching.

The shape simulation adopted in the virtual inspection is not restricted to such a three-dimensional physicochemical model as described here, but a three-dimensional geometric model may be adopted, or a two-dimensional physicochemical model or a geometric model may be used. Moreover, the simulation parameters used in the shape simulation may be appropriately selected in accordance with an accuracy required for the simulation.

As to the modeling of the simulation at the step 102 in FIG. 2, in a selected simulation model, the initial shape parameters T1, T2, T3, T4, d1, and a1 are input and the parameters for the simulation model are adjusted in such a manner that the shape parameters T11, T12, d11, d12, d13, and d14 of a shape after the etching treatment can be reproduced.

Then, sensitivity analysis among the input parameters is executed, and control parameters to be controlled during the manufacturing process are extracted (a step S103 in FIG. 2). It is desirable for the initial shape parameters as sensitivity analysis targets to belong to an in-line-measurable shape parameter group. If they belong to such a group, we can easily find the point which in-line measurement data is important, and we can improve the accuracy of the virtual inspection by improving the measurement method. In a case of an inspection of the contact hole shown in FIG. 5, an inspection index is, e.g., the shape parameter d11, a defect in this inspection is a situation where a contact is not formed, i.e., a situation where d11=0 occurs.

In the parameter sensitivity analysis, parameter variations substantially equal to those that are produced during the manufacturing process are given to the input parameters T1, T2, T3, T4, d1, and a1 in the simulation, and influence on the inspection index d11 by each input parameter is quantified (i.e., sensitivity value). As a result, all parameters having high sensitivity can be extracted as control parameters that should be heavily controlled in the manufacturing process.

(2) Implementation of Inspection (Step S200)

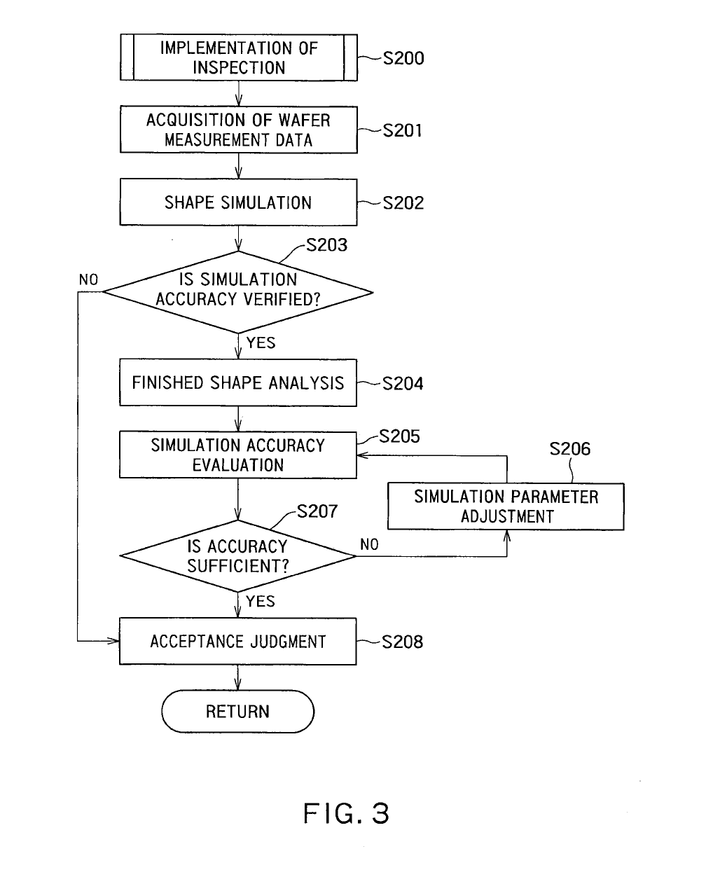

Details of the inspection implementation procedure will now be described with reference to a flowchart of FIG. 3.

First, an actual pattern which contains the virtual inspection target is formed on a wafer, and in-line wafer measurement data of the control parameter extracted at the step S103 in FIG. 2 is acquired (a step S201). If the control parameter extracted at the step S103 in FIG. 2 is not subjected to the in-line measurement in the manufacturing process, a new measurement process is added to measure the control para meter.

Giving explanation with reference to the example shown in FIG. 4A and FIG. 4B, for example, in the case in which the taper angle a1 of the mask material in FIG. 4A has been extracted as a top-priority control parameter at the step S103, but there is no measurement process for the taper angle a1, a new measurement process to get the taper angle a1 is added. As a specific method, the hole top diameter d1 and the hole bottom diameter d2 of the hard mask 105 shown in FIGS. 4A and 4B are measured by using the scanning electron microscope (not shown) for pattern measurement, and combining these values with a value of T4 acquired from the optical film thickness measurement enables calculating the taper angle a1.

Then, data obtained at the step S201 is determined as an input parameter, the shape simulation is executed, and a pattern shape after etching which is a virtual inspection target is estimated (a step S202).

Although the modeling of the shape simulation has been once performed in the preparatory procedure in the step S100, a simulation accuracy have to be verified at a predetermined interval or at timing that a fluctuation in apparatus or a fluctuation in manufacturing process is recognized (YES at a step S203).

In some cases in which the accuracy verification is not required (NO at the step S203), acceptance of the inspection is judged based on a result of the shape simulation (a step S208). For example, in the inspection of the contact hole forming process in FIG. 5, if the contact hole diameter d11 is 0 as a result of the simulation, this state is determined as a defect since the contact hole is not opened, and an alarm is output. If the contact hole diameter d11>0, it is determined that a contact is formed in the silicon substrate 101, and the pattern passes the inspection. If the accuracy verification is not executed, then the virtual inspection is terminated.

On the other hand, if the accuracy verification of the simulation has been determined to be executed at the step S203, the processing advances to finished shape analysis (a step S204). The shape analysis here includes a destructive analysis technique.

Subsequently, a simulation result obtained at the step S202 is compared with a finished shape analysis result obtained at S204, and an accuracy evaluation of the shape simulation is performed (a step S205). If the accuracy has been determined to be insufficient, each simulation parameter is adjusted (a step S206), and the adjustment of the simulation parameter is repeated until the accuracy is determined to be sufficient (steps S205, S207, and S206). If the simulation accuracy has been determined to be sufficient at the simulation accuracy judgment (the step S207), the processing advances to an inspection acceptance judgment (a step S208). Just after the destructive analysis in the step S204, the inspection acceptance judgment can be decided based on the analysis. The shape simulation in which the parameter adjustment has been performed is used for the virtual inspection of subsequent wafers.

With the above-described procedure, the virtual inspection in one manufacturing process is terminated.

According to the pattern inspection method based on at least one of the above-described embodiments, the pattern shape inspection, which was difficult in a non-destructive manner due to a high aspect ratio and the like, can be conducted by using the in-line measurement data and the shape simulation. As a result, a high-speed pattern inspection can be performed at low cost. Furthermore, since each control parameter that greatly affects an inspection index can be extracted by the shape simulation, an important point in the in-line measurement can be recognized in advance, and the efficient semiconductor manufacturing process control can be carried out.

(B) Manufacturing Control System

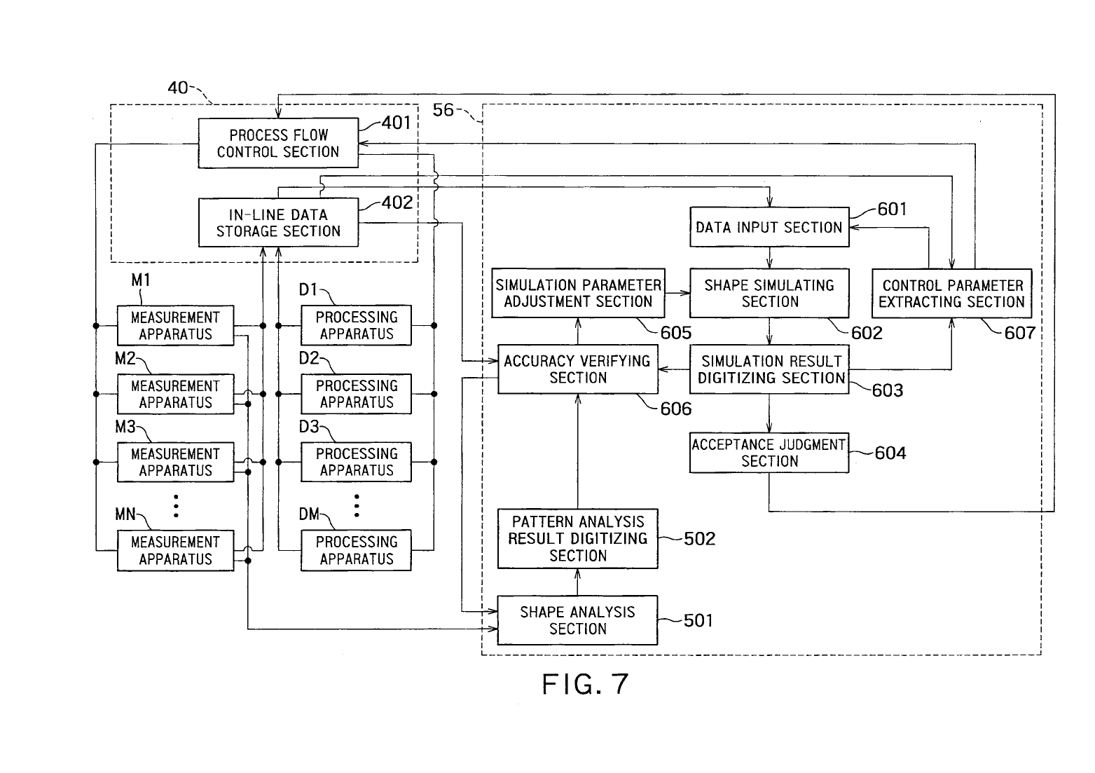

An embodiment of a manufacturing control system will now be described with reference to a block diagram of FIG. 7. The manufacturing control system shown in FIG. 7 is a system configured to control a semiconductor manufacturing apparatus by using the pattern inspection method according to the foregoing embodiment.

The manufacturing control system according to this embodiment includes a manufacturing control unit 40 and a virtual inspection unit 56, and these units are connected to respective external processing apparatuses D1, D2, D3 . . . DM (M is a natural number which is not smaller than 2) and measurement apparatuses M1, M2, M3 . . . MN (N is a natural number which is not smaller than 2). Respective apparatus parameters of the processing apparatuses D1 to DM are monitored by non-illustrated sensors.

The manufacturing control unit 40 includes a process flow control section 401 and an in-line data storage section 402.

The process control section 401 is connected to the processing apparatuses D1 to DM and the measurement apparatuses M1 to MN, generates control signals, supply them to these apparatuses, and controls orders of a manufacturing process and a measurement process in a manufacturing line.

The in-line data storage section 402 is connected to the processing apparatuses D1 to DM and the measurement apparatuses M1 to MN. The in-line data storage section 402 receives the respective apparatus parameters of the processing apparatuses D1 to DM from the sensors (not shown) provided to the processing apparatuses D1 to DM and stores these parameters. The in-line data storage section 402 also receives measurement data from the measurement apparatuses M1 to MN and stores these pieces of data.

The virtual inspection unit 56 includes a data input section 601, a shape simulating section 602, a simulation result digitizing section 603, an acceptance judgment section 604, a control parameter extracting section 607, a shape analysis section 501, a pattern analysis result digitizing section 502, an accuracy verifying section 606, and a simulation parameter adjustment section 605.

The data input section 601 is connected to the shape simulating section 602 and supplies data of a simulation model together with each initial shape parameter to the shape simulating section 602. The data input section 601 is also connected to the in-line data storage section 402 and can input to the shape simulating section 602 input parameters reflecting the in-line measurement data from the measurement apparatuses M1 to MN or the apparatus data obtained from the processing apparatuses D1 to DM through the in-line data storage section 402.

The data input section 601 is also connected to the control parameter extracting section 607, and the control parameter extracting section 607 is also connected to the in-line data storage section 402. At the time of executing the parameter sensitivity analysis simulation, although each input parameter for the simulation must be fluctuated and then inputted to the data input section 601, the control parameter extracting section 607 reflects manufacturing process unevenness data stored in the in-line data storage section 402, creates each fluctuated parameter, and inputs this parameter to the data input section 601.

The simulation result digitizing section 603 is connected to the shape simulating section 602, the control parameter extracting section 607, the accuracy verifying section 606, and the acceptance judgment section 604, digitizes each shape parameter representing features of a pattern shape from shape data supplied from the shape simulating section 602, and supplies it to the control parameter extracting section 607, the accuracy verifying section 606, and the acceptance judgment section 604.

The control parameter extracting section 607 performs a parameter sensitivity analysis from input data inputted to the data input section 601 for the parameter sensitivity analysis simulation and output data obtained from the simulation result digitizing section 603 at that moment, and extracts each shape parameter that should be controlled in the manufacturing process. The control parameter extracting section 607 supplies the extracted shape parameter to the process flow control section 401 as a control parameter and thereby feeds back to the manufacturing process.

The process flow control section 401 that has received the control parameter from the control parameter extracting section 607 allows the measurement apparatuses M1 to MN to perform the in-line measurement in regard to the control parameter in the manufacturing process of an inspection target pattern. The acquired in-line wafer measurement data is supplied to the data input section 601 through the in-line data storage unit 402. It is to be noted that, if the in-line measurement in regard to the control parameter is not present in the current in-line measurement process, the control parameter extracting section 607 creates a designation signal and supplies it to the process flow control section 401, and the process flow control section 401 adds the designated in-line measurement as a new in-line measurement process.

The shape simulating section 602 receives a parameter which reflects an in-line measurement result in regard to the control parameter through the data-input section 601, newly carries out the shape simulation, and supplies shape data as a simulation result to the simulation result digitizing section 603.

The simulation result digitizing section 603 digitizes the shape data and supplies a shape parameter that reflects the simulation result to the acceptance judgment section 604 as an inspection index. The acceptance judgment section 604 makes an inspection acceptance judgment of the inspection target pattern from the supplied inspection index in units of wafer. If the pattern has failed to pass the inspection, the acceptance judgment section 604 feeds back this information to the process flow control section 401.

The accuracy verifying section. 606 is connected to the in-line data storage section 402, the shape analysis section 501, the pattern analysis result digitizing section 502, the simulation result digitizing section 603, and the simulation parameter adjustment section 605.

The accuracy verifying section 606 receives a fluctuation amount of the measurement data or a fluctuation amount of the apparatus parameter from the in-line data storage section 402. If the accuracy verifying section 606 has detected that each of these fluctuation amounts exceeds a given threshold value, it determines that a simulation accuracy verification is required, and supplies a command to perform a shape analysis on a wafer to the shape analysis section 501. Furthermore, the accuracy verifying section 606 includes a non-illustrated timer, and it supplies a command to perform a shape analysis on the wafer to the shape analysis section 501 when a fixed period of time has elapsed even though the fluctuation amount of the measurement data or the fluctuation amount of the apparatus parameter does not exceed the given threshold value.

The shape analysis section 501 is connected to the measurement apparatuses M1 to MN, and it can use wafer measurement data obtained by the in-line measurement and perform the shape analysis in addition to a destructive analysis effected by an external apparatus (not shown).

The shape data obtained in the shape analysis section 501 is converted into numeric data by the pattern analysis result digitizing section 502 and supplied to the accuracy verifying section 606. The analysis verifying section 606 compares data of a pattern analysis result supplied from the pattern analysis result digitizing section 502 with data of a simulation result supplied from the simulation result digitizing section 603, thereby effecting an accuracy evaluation of the shape simulation. If the accuracy of the shape simulation has been determined to be insufficient as a result of the evaluation, the accuracy verifying section 606 supplies this information to the simulation parameter adjustment section 605, and the simulation parameter adjustment section 605 adjusts the simulation parameter. The above-described accuracy verification is repeated until a sufficient accuracy is obtained, and the simulation parameter provided at the time of acquisition of the sufficient accuracy is supplied to the shape simulating section 602.

According to the manufacturing control system based on at least one of the foregoing embodiments, since the in-line measurement data and the shape simulation are used, the inspection of a pattern shape, which was difficult in a non-destructive manner due to a high aspect ratio and the like, can be performed in a non-destructive manner. As a result, a semiconductor device can be manufactured at low cost with high throughput. Moreover, since a control parameter that greatly affects an inspection index is extracted by the shape simulation and an important point in the in-line measurement is detected in advance, the efficient manufacturing process control can be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern inspection method comprising:
modeling a shape simulation of a pattern;
performing in-line measurement with respect to control parameters which are to be controlled in a manufacturing process of the pattern;
executing the shape simulation by using a result of the in-line measurement; and
judging acceptance of a pattern shape based on a result of the shape simulation.

2. The method of claim 1, further comprising performing a sensitivity analysis of parameters of the shape simulation,
wherein the control parameters are extracted from a result of the sensitivity analysis.

3. The method of claim 2,
wherein the sensitivity analysis is performed in regard to a parameter which is measurable in an in-line manner in the parameters.

4. The method of claim 2, comprising adding the in-line measurement for the extracted control parameters to the manufacturing process when the control parameters are extracted from parameters which are unobtainable by current in-line measurement.

5. The method of claim 1, further comprising:
analyzing a shape of an actual pattern formed on a substrate in regard to the pattern; and
evaluating an accuracy of the shape simulation from a result of the shape simulation and a result of the actual pattern shape analysis.

6. The method of claim 5,
wherein analyzing the actual pattern shape comprises analyzing a surface shape, a cross-sectional shape, or a three-dimensional shape thereof by at least one of in-line measurement and a destructive analysis.

7. The method of claim 5,
wherein the analysis of the actual pattern shape is performed at a predetermined interval or at timing that a fluctuation in a manufacturing apparatus or a manufacturing process is recognized.

8. The method of claim 5, further comprising adjusting a simulation parameter of the shape simulation when the accuracy of the shape simulation is determined to be insufficient.

9. The method of claim 1,
wherein the modeling of the shape simulation is performed by using a two-dimensional or three-dimensional physicochemical model or geometric model.

10. A manufacturing control system comprising:
a process flow control section which controls a manufacturing process of an external manufacturing apparatus;
a shape simulating section which is connected to an external measurement apparatus, receives in-line measurement data, and executes a shape simulation of a pattern;
a simulation result digitizing section which digitizes shape features of the pattern from a simulation result of the shape simulating section and outputs them; and
an acceptance judgment section which judges acceptance of the pattern based on output data from the simulation result digitizing section, and, in a case of unacceptance, supplies information on the unacceptance to the process flow control section.

11. The system of claim 10, further comprising a control parameter extracting section which performs a sensitivity analysis of parameters of the shape simulation and extracts control parameters which are to be controlled in a manufacturing process of the pattern.

12. The system of claim 11,
wherein the control parameter extracting section performs a sensitivity analysis in regard to a parameter which is measurable in an in-line manner in the parameters of the shape simulation.

13. The system of claim 11,
wherein, when parameters which are unobtainable by current in-line measurement are extracted as the control parameters, the control parameter extracting section generates a signal designating addition of the in-line measurement for the extracted control parameters and supplies the signal to the process flow control section.

14. The system of claim 10, further comprising:
a shape analysis section which analyzes a shape of an actual pattern formed on a substrate in regard to the pattern;
a pattern analysis result digitizing section which digitizes shape features of the actual pattern from an analysis result obtained by the shape analysis section; and
an accuracy verifying section which compares output data from the simulation result digitizing section and output data from the pattern analysis result digitizing section and verifies an accuracy of the shape simulation.

15. The system of claim 14,
wherein the shape analysis section analyzes a surface shape, a cross-sectional shape, or a three-dimensional shape of the actual pattern by at least one of the in-line measurement and a destructive analysis.

16. The system of claim 14,
wherein the shape analysis section analyzes a shape of the actual pattern at a predetermined interval or at timing that a fluctuation in the external manufacturing apparatus or a manufacturing process is recognized.

17. The system of claim 14, further comprising a simulation parameter adjustment section which adjusts a simulation parameter that is input to the shape simulating section when the accuracy verifying section determines that the accuracy of the shape simulation is insufficient.

18. The system of claim 10,
wherein the shape simulating section executes the shape simulation by using a two-dimensional or three-dimensional physicochemical model or geometric model.
